(19) United States
(12) Patent Application Publication
(10) Pub. No.: US 2023/0168495 A1
(43) Pub. Date: Jun. 1, 2023

(54) CHROMATIC FOCAL SHIFT COMPENSATION METHODS AND SYSTEMS

(71) Applicant: Applied Materials, Inc., Santa Clara, CA (US)

(72) Inventors: Ang Li, Santa Clara, CA (US); Danni Wang, Sunnyvale, CA (US); Jean-Marc Fan Chung Tsang Min Ching, Sunnyvale, CA (US)

(73) Assignee: Applied Materials, Inc., Santa Clara, CA (US)

(21) Appl. No.: 18/070,643

(22) Filed: Nov. 29, 2022

Related U.S. Application Data
(60) Provisional application No. 63/283,729, filed on Nov. 29, 2021.

(51) Int. Cl. G02B 27/00; G02F 1/1335

(52) U.S. Cl. CPC G02B 27/0062; G02B 27/0068; G02F 1/133526

(57) ABSTRACT

Methods and systems of correcting chromatic focal shift may include measuring a chromatic focal shift in focal points of a lens between first and second wavelengths of light passing through the lens. They also include detecting the first wavelength of light from a sample spaced at a first distance between the sample and the lens that corresponds to a first focal point for the first wavelength of light. They further include adjusting the sample and the lens to a second distance with a piezoelectric actuator. The second distance may be determined using the measurement of the chromatic focal shift between the first and second wavelengths of light passing through the lens. They additionally include detecting a second wavelength of light from the sample spaced at the second distance between the sample and the lens, where the second distance corresponds to a second focal point for the second wavelength of light.

### CROSS-REFERENCE TO RELATED APPLICATIONS

This application claims the benefit of, and priority to U.S. Provisional Application Ser. No. 63/283,729, filed Nov. 29, 2021, which is hereby incorporated by reference in its entirety for all purposes.

### TECHNICAL FIELD

The present technology relates to methods and systems to correct for chromatic focal shifts in the microscopic imaging of samples. More specifically, the present technology relates to methods and systems to keep different wavelengths of light passing through a lens in focus on a detector.

### BACKGROUND

Microscopic imaging plays an important role in the imaging of many types of compounds, materials, and miniaturized devices, among other kinds of samples. In many cases, the samples being imaged emit light at divergent wavelengths. For example, the fluorescence imaging of biological samples such as tissues, proteins, and nucleic acid polymers, among other biological samples, involves the detection of both exogenous and endogenous fluorescent compounds. These fluorescent compounds commonly emit light at widely divergent wavelengths.

In many cases, the widely divergent wavelengths of light projected through the imaging lens of a microscopic system experience a chromatic focal shift. This can be understood as a change in the focal point of the light passing through the lens depending on the wavelength of light being focused. When the difference in wavelengths is small (e.g., less than 5 nm), the chromatic focal shift is barely detectable. However, when the difference in wavelengths is larger, a chromatic focal shift can cause an image to be significantly out of focus at a stationary detector for at least one of the wavelengths. Thus, there is a need for improved methods and systems that can image a sample emitting divergent wavelengths of light with a stationary detector.

### SUMMARY

Embodiments of the present technology include methods of correcting chromatic focal shift. The methods include measuring a chromatic focal shift in focal points of a lens between first and second wavelengths of light passing through the lens. The methods also include detecting the first wavelength of light from a sample spaced at a first distance between the sample and the lens that corresponds to a first focal point for the first wavelength of light. The methods further include adjusting the sample and the lens to a second distance with a piezoelectric actuator. The second distance is determined using the measurement of the chromatic focal shift between the first and second wavelengths of light passing through the lens. The methods additionally include detecting a second wavelength of light from the sample spaced at the second distance between the sample and the lens, where the second distance corresponds to a second focal point for the second wavelength of light.

In additional embodiments, the first and second wavelengths of light are wavelengths of visible light or near-infrared light. In further embodiments, the first wavelength of light and the second wavelength of light differ in wavelength by greater than or about 50 nm. In still further embodiments, the piezoelectric actuator moves the lens to the second distance while the sample remains stationary. In more embodiments, the piezoelectric actuator moves the sample to the second distance while the lens remains stationary. In yet additional embodiments, the method further includes adjusting a focusing power of the lens, where the focusing power of the lens is adjusted by adjusting a shape of the lens or a refractive index of the lens to reduce a change in a focal point of the lens due to the chromatic focal shift. In still more embodiments, the first and second wavelengths of light correlate with emission wavelengths of one or more fluorescent dyes present in the sample. In further embodiments, the sample includes a dyed nucleic acid polymer.

Embodiments of the present technology also include methods of adjusting a lens to correct chromatic focal shift. The methods include measuring a chromatic focal shift in focal points of a lens between first and second wavelengths of light passing through the lens. The methods further include detecting the first wavelength of light from a sample, where the lens has a focusing power that creates a first focal point corresponding to a fixed distance between the sample and a detector for the first wavelength of light from the sample. The methods also include adjusting the lens to a second focusing power, where the second focusing power of the lens creates a second focal point corresponding to the fixed distance between the sample and the detector for the second wavelength of light from the sample. The second focusing power is determined using the measurement of the chromatic focal shift between the first and second wavelengths of light passing through the lens. The methods still further include detecting the second wavelengths of light from the sample.

In additional embodiments, the adjustment of the lens to the second focusing power includes adjusting a shape of the lens with a piezoelectric actuator, where the piezoelectric actuator adjusts the lens from a first shape at the first focusing power to a second shape at the second focusing power by stretching the lens to reduce a thickness in a central portion of the lens. In further embodiments, the adjustment of the lens to the second focusing power includes adjusting a refractive index of the lens by applying an electric field to the lens, where the electric field adjusts the lens from a first refractive index at the first focusing power to a second refractive index at the second focusing power. In further embodiments, the method also includes adjusting the sample and the lens a second distance apart that is different than the fixed distance, and detecting a third wavelength of light from the sample that is different than the first or second wavelength of light, and where the second distance corresponds to a third focal point for the third wavelength of light. In more embodiments, the first wavelength of light and the second wavelength of light differ in wavelength by greater than or about 50 nm. In yet more embodiments, the sample includes a dyed nucleic acid polymer.

Embodiments of the present technology further include microscope systems that include a lens and a support operable to secure a sample in a position where at least a portion of light emitted by the sample is focused by the lens on a detector. The systems also include a piezoelectric actuator coupled to one or both of the lens and the support, where the piezoelectric actuator is operable to adjust a distance between the lens and the support. The systems additionally include a controller operable to be in electronic communication with the piezoelectric actuator, where the controller is operable to instruct the piezoelectric actuator to adjust a distance between the lens and the support to focus different wavelengths of the light emitted by the sample on the detector.

In additional embodiments, the systems further include a light source operable to illuminate the sample secured to the support with a fluorescence excitation light. In further embodiments, the different wavelengths of the light emitted by the sample comprise first and second wavelengths of light, where the first and second wavelengths of light differ in wavelength by greater than or about 50 nm. In still further embodiments, the first and second wavelengths of light are wavelengths of visible light or near-infrared light. In yet more embodiments, the lens is made of a translucent organic polymer that is operable to change shape. In still additional embodiments, the lens includes a liquid crystal material that is operable to change a refractive index of the lens in response to a change in an electric field applied to the lens.

Embodiments of the present technology provide improved imaging of samples that emit light at two or more divergent wavelengths. In embodiments, the present technology corrects a chromatic focal shift in the focal point of light of different wavelengths that pass through a lens that magnifies an image from at least a portion of a sample. The correction permits the image projected through the lens to be in focus at the same point for the different wavelengths. In further embodiments, the lens can project a focused image with two or more divergent wavelengths onto a stationary detector. In still further embodiments, the sample that is imaged through the lens may include fluorescent compounds that emit fluorescence excitation light at two or more wavelengths which differ in wavelength by greater than or about 50 nm. In embodiments, the chromatic focal shift is corrected by changing the distance between the lens and the sample when capturing an image of the sample, changing the focusing power of the lens when capturing the image, or both. The present technology eliminates the need to make customized lenses from composite materials having different indices of refraction that allow the lenses to maintain a constant focal point across a range of wavelengths emitted by the sample. These and other embodiments, along with many of their advantages and features, are described in more detail in conjunction with the below description and attached figures.

### BRIEF DESCRIPTION OF THE DRAWINGS

A further understanding of the nature and advantages of the disclosed embodiments may be realized by reference to the remaining portions of the specification and the drawings.

FIGS. 1A-B are diagrams illustrating the chromatic focal shift of two wavelengths of light passing through a lens.

FIG. 2 shows a flowchart with selected operations in a method of correcting chromatic focal shift according to embodiments of the present technology.

FIG. 3 shows another flowchart with selected operations in a method of adjusting a lens to correct a chromatic focal shift according to embodiments of the present technology.

FIGS. 4A-B show simplified schematic drawings of microscope systems according to embodiments of the present technology.

Several of the figures are included as schematics. It is to be understood that the figures are for illustrative purposes and are not to be considered of scale unless specifically stated to be of scale. Additionally, as schematics, the figures are provided to aid comprehension and may not include all aspects or information compared to realistic representations and may include exaggerated material for illustrative purposes.

In the figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION

Optical microscopy is used to magnify an image of a sample by passing the light reflected from or emitted by the sample through one or more magnifying lenses. In optical fluorescence microscopy, the sample includes one or more fluorescent compounds that, when excited, emit light that can be imaged through the microscope's lenses. The fluorescent compounds may also include one or more binding groups that may bind to specific compounds or parts of compounds in the sample being imaged. These fluorescent compounds that bind only to specific sites and groups on compounds in the sample can help create a fluorescence image of the sample that shows the spatial distribution of the tagged compounds.

In many instances, a sample is prepared with two or more fluorescent compounds that bind to different compounds or parts of compounds in the sample. The fluorescent compounds are typically selected to fluoresce at different wavelengths of light so the compounds can be distinguished in the fluorescence image of the sample. The different fluorescent compounds may also be selected to fluoresce at wavelengths that are sufficiently spaced apart, so they are clearly distinguished from each other in the fluorescence image of the sample. In additional instances, a single fluorescent compound may fluoresce at two or more different wavelengths to provide a more distinct signature for the compound. This can be useful for samples that emit a lot of background light, such as the autofluorescence of one or more endogenous compounds in the sample.

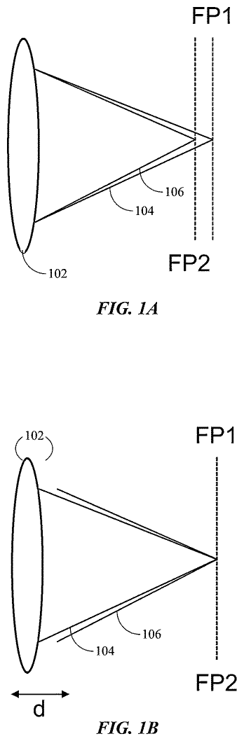

Unfortunately, the focal points of different wavelengths of light are shifted from each other when passing through the lenses of a fluorescence microscope. As shown in FIG. 1A, the lens 102 focuses a first wavelength of light 104 to a first focal point (FP1) and a second wavelength of light 106 to a second focal point (FP2). The chromatic focal shift is the difference in length between FP1 and FP2 for the lens 102. For differences in light wavelengths of a nanometer or less, the chromatic focal shift is small and usually doesn't create noticeable blurring and distortions of the fluorescence images. However, for wavelength differences of greater than or about 10 nm, greater than or about 25 nm, greater than or about 50 nm, or more, the chromatic focal shift can cause significant blurring and distortion of a fluorescence image. In many instances, the image is unusable without correcting for the chromatic focal shift.

One conventional correction method is to use a lens that can maintain a constant focal point across the range of light wavelengths that are focused through the lens. Such lenses may be made by combining layers of different materials, shapes, and thicknesses into a compound lens that can focus the different wavelengths of light to the same focal point. This correction method can prove challenging and expensive when the range of light wavelengths exceeds about 10 nm, about 20 nm, or more. In many instances, it is unworkable for wavelengths of light that are separated by greater than or about 50 nm.

Another conventional method takes two or more images of the sample with alternative lenses that focus different wavelengths of light to the same focal point. In many instances, the different images cannot be combined into a single image. In further instances, the fluorescence image changes rapidly over time, and the different lenses image the sample at different times.

The present technology corrects a chromatic focal shift without resorting to making complex, expensive compound lenses. In embodiments of the present technology, a distance between the lens and the sample may be shifted to maintain the same focal point for the different wavelengths of light passing through the lens. FIG. 1B shows this shift in the position of the lens 102 (“d”) from a first position LP1 to a second position LP2 to correct for the chromatic focal shift between the first wavelength of light 104 and the second wavelength of light 106. The change in the position of the lens 102 corrects for the chromatic focal shift by keeping the focal points FP1 and FP2 at the same position despite having different focal lengths due to the chromatic focal shift.

In further embodiments, the present technology corrects the chromatic focal shift by changing the focusing power of the lens to keep the focal points in the same location for the different wavelengths of light. In embodiments, the change in focusing power may be affected by a change in the shape of the lens. In further embodiments, the shape of the lens may be changed by an actuator that may be attached to the periphery of the lens and is operable to stretch or compress the shape of the lens. In additional embodiments, the actuator may be a piezoelectric actuator that changes the shape of the lens in response to changes in an electric field applied to a piezoelectric material in the actuator. The change in shape may be reversible by changing back the applied electric field. In additional embodiments, changing the focusing power of the lens may include changing a refractive index of the lens. In embodiments, the lens may include a material that changes its refractive index in response to a change in an electric field applied to the material. In further embodiments, the material may include a liquid crystal that changes its refractive index in response to a change in an applied electric field.

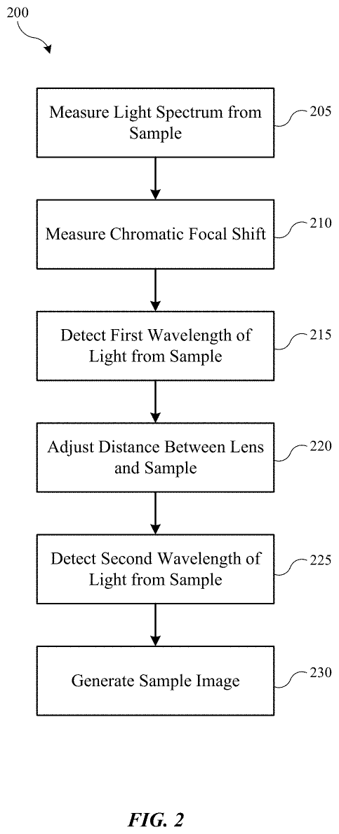

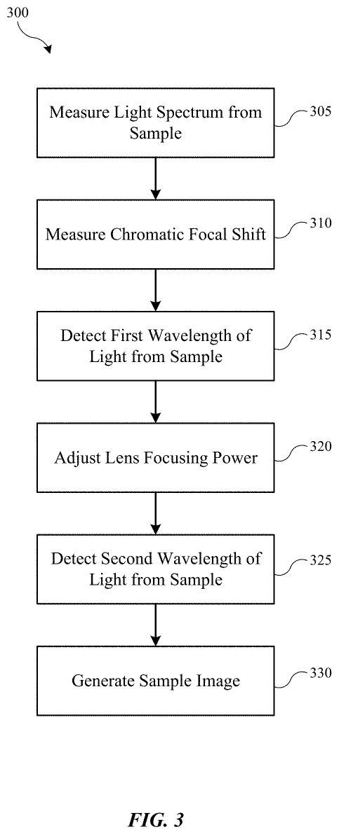

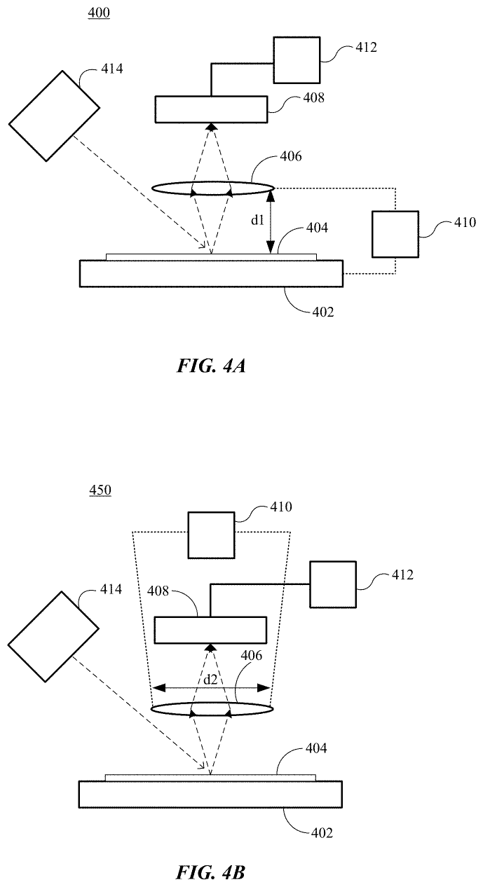

FIG. 2 and FIG. 3 show flowcharts illustrating some of the operations in embodiments of the present methods to correct chromatic focal shift in sample images taken with optical microscopes. FIGS. 4A-B show simplified schematic drawings of embodiments of microscope systems according to the present technology that may be used to carry out embodiments of the present methods. Method 200 in FIG. 2 and method 300 in FIG. 3 may be performed with the components of microscope system 400 shown in FIG. 4. Methods 200 and 300 may or may not include operations prior to the initiation of the methods, including the cutting, fixing, and dying of the sample to be imaged by microscope system 400. Methods 200 and 300 may also include a number of optional operations, which may or may not be specifically associated with some embodiments of methods according to the present technology.

FIGS. 2 and 3 include methods 200 and 300, respectively, which include measuring the light spectrum from a sample (such as sample 404 shown in FIGS. 4A-B) at operations 205, 305. In embodiments, these measurements may be used to identify wavelengths of light at one or more emission peaks from the sample 404. In further embodiments, the identified emission peaks in the light spectrum may be used to determine a spatial adjustment in a distance (“d1”) between the sample 404 and lens 406 to correct a chromatic focal shift caused by a difference in the wavelengths of emitted light at the different emission peaks. In additional embodiments, the spatial adjustment in distance (d1) may be less than or about 2000 nm, less than or about 1500 nm, less than or about 1000 nm, less than or about 900 nm, less than or about 800 nm, less than or about 700 nm, less than or about 600 nm, less than or about 500 nm, less than or about 400 nm, less than or about 300 nm, less than or about 200 nm, less than or about 100 nm, or less. In additional embodiments, the spatial adjustments may be input into a controller that is in electronic communication with a piezoelectric actuator 410. The controller may further be operable to adjust an electric field applied to the piezoelectric actuator 410 to cause the actuator to make a spatial adjustment in the distance (d1) between the lens 406 and the sample 404, as shown in FIG. 4A.

In other embodiments, the piezoelectric actuator 410 makes an adjustment in the focusing power of the lens. In embodiments, the adjustment in the focusing power may range from about −20 diopters to about 20 diopeters. In additional embodiments, the adjustment in the focusing power of the lens may involve changing the shape (“d2”) of the lens 406, as shown in FIG. 4B. In still further embodiments, the adjustment in the focusing power may involve changing a refractive index of the lens. In more embodiments, the change in refractive index may be greater than or about 0.01, greater than or about 0.025, greater than or about 0.05, greater than or about 0.075, greater than or about 0.1, greater than or about 0.125, greater than or about 0.15, greater than or about 0.175, greater than or about 0.2, greater than or about 0.25, greater than or about 0.3, greater than or about 0.35, greater than or about 0.4, greater than or about 0.45, greater than or about 0.5, or more.

In embodiments, the sample 404 may be an inorganic sample, such as rock or mineral, or an organic sample, such as an organic polymer or biological sample. In further embodiments, the biological samples may include sections of biological tissue, cell cultures, proteins, and nucleic acid polymers, among other kinds of biological samples. In still further embodiments, the nucleic acid samples may include polymers of deoxyribonucleic acid (DNA) and ribonucleic acid (RNA), among other nucleic acid polymers.

In still more embodiments, the sample 404 may include one or more exogenous fluorescent compounds that emit fluorescent light when excited with a light source 414. These exogenous fluorescent compounds may be introduced to the sample 404 before it is imaged by microscope systems 400, 450. In additional embodiments, the exogenous fluorescent compounds may include one or more binding groups that selectively bind the compound to a target compound or portion of a compound in the sample. A sample 404 prepared with these selectively binding, exogenous fluorescent compounds may produce a fluorescence image of the sample, or a portion of the sample, that reveals a spatial distribution of the target compound in the sample.

Methods 200, 300 may also include measuring a chromatic focal shift between two or more wavelengths of peak light emission from the sample 404 at operations 210, 310. In embodiments, the chromatic focal shift measurements may include empirical measurements of the focal points of the light produced by the lens 406 at each of the wavelengths. For example, the adjustment of one or more of the detector 408, lens 406, or sample holder 402 may be used to measure a focal distance for each wavelength of light passing through the lens. The difference in focal distance may be used to determine the difference in the focal point for each of the wavelengths of light passing through the lens 406. In additional embodiments, the chromatic focal shift measurement may be performed by calculating a focal distance based on one or more characteristics of the lens 406 and the wavelength of light passing through the lens. In more embodiments, these lens characteristics may include the shape of the lens, the thickness of the lens, and the materials used to make the lens, among other lens characteristics.

In embodiments, the magnitude of the chromatic focal shift depends on the material used to make the lens 406. In further embodiments, the lens 406 may be made from a single material. In still further embodiments, the lens 406 may be made from two or more different materials. In yet additional embodiments, the lens 406 may be made of at least one material such as crown glass, flint glass, N-BK7 glass, N-SF11 glass, fused silica, calcium fluoride, and magnesium fluoride, among other types of lens material. In more embodiments, the lens 406 may be made from a combination of crown glass and flint glass that reduces the chromatic focal shift over a range of light wavelengths in the visible spectrum, the near-infrared spectrum, or both.

Methods 200, 300 may further include detecting a first wavelength of light from the sample 404 at operations 215, 315. In embodiments, the first wavelength of light may be generated by illuminating or exciting the sample with light from light source 414. In further embodiments, the first wavelength of light may include light from a first fluorescence emission peak emitted by excited fluorescent compounds bound to a target compound in the sample 404. In more embodiments, the first wavelength of light may be characterized as visible light having a wavelength in the range of 350 nm to 750 nm. In further embodiments, the first wavelength of light may be characterized as near-infrared light having a wavelength range of 750 nm to 2000 nm. In still more embodiments, the first wavelength of light may be a peak wavelength of emitted light that is characterized by a full-width-half-maximum (FWHM) spectral width of less than or about 100 nm, less than or about 75 nm, less than or about 50 nm, less than or about 25 nm, less than or about 20 nm, less than or about 15 nm, less than or about 10 nm, less than or about 5 nm, or less.

Method 200 may still further include adjusting a distance (d1) between the sample 404 and the lens 406 at operation 220. The adjustment is made to maintain the focal point in the same place on the detector 408 for the first and second wavelengths of light that are detected. In embodiments, the adjustment is made using the piezoelectric actuator 410 that is mechanically attached to one or both of the sample holder 402 and lens 406, as shown in FIG. 4A. In some embodiments, the adjustment of the distance (d1) may be made by moving the sample holder 402 with the piezoelectric actuator 410 while keeping the lens 406 in a fixed position. In additional embodiments, the adjustment of the distance (d1) may be made by moving the lens 406 with the piezoelectric actuator 410 while keeping the sample holder 402 in a fixed position. In yet additional embodiments, the piezoelectric actuator 410 may move both the sample holder 402 and the lens 406 when adjusting the distance (d1).

In embodiments, the change in distance (d1) may be determined from the measurement in the chromatic focal shift between the first and second wavelengths at operation 210. In further embodiments, the change in distance (d1) may be proportional to the difference in the focal length of the first and second wavelengths of light passing through the lens 406 from the sample 404. In more embodiments, the change in distance (d1) may be input to a controller that is electronically coupled to the piezoelectric actuator 410. The controller may translate the inputted change in the distance (d1) to a change in the strength of an electric field applied to the piezoelectric actuator 410. The change in the applied electric field may cause the piezoelectric material in the piezoelectric actuator 410 to move the sample holder 402 and/or lens 406 to the new distance (d1) until the controller receives instructions to change the distance (d1) again.

Method 300 may include adjusting the focusing power of the lens 406 at operation 320. The adjustment is made to maintain the focal point in the same place on the detector 408 for the first and second wavelengths of light that are detected. In embodiments, adjusting the focusing power of the lens 406 may include adjusting the shape of the lens. In further embodiments, the change in the shape of lens 406 may be affected by a piezoelectric actuator 410 that is attached to the periphery of the lens, as shown in FIG. 4B. In more embodiments, the adjustment to the shape of the lens 406 may be made by applying an electric field to the piezoelectric material in the piezoelectric actuator 410, which causes the actuator to stretch or compress the shape of the lens. In yet further embodiments, the piezoelectric actuator 410 may be attached to a plurality of points on the periphery of the lens 406, and may both stretch and compress portions of the lens.

In more embodiments, the change in the shape of the lens 406 may be determined from the measurement in the chromatic focal shift between the first and second wavelengths at operation 310. In further embodiments, the change in the shape of the lens 406 may be proportional to the difference in the focal length of the first and second wavelengths of light passing through the lens 406 from the sample 404. In more embodiments, the change in the shape of the lens 406 may be input to a controller that is electronically coupled to the piezoelectric actuator 410. The controller may translate the inputted change in the shape to a change in the strength of an electric field applied to the piezoelectric actuator 410. The change in the applied electric field may cause the piezoelectric material in the piezoelectric actuator 410 to adjust the lens 406 to the new shape until the controller receives instructions to change the shape again.

In further embodiments, the adjusting the focusing power of the lens 406 may include adjusting the refractive index of the lens. In embodiments, the adjustment in the refractive index may include applying an electric field to the lens 406. In these embodiments, the lens 406 includes one or more materials that changes its refractive index in response to a change in electric field, such as a liquid crystal.

Methods 200, 300 may still further include detecting a second wavelength of light from the sample 404 at operation 225, 325. In embodiments, the second wavelength of light may be generated by illuminating or exciting the sample with light from light source 414. In further embodiments, the second wavelength of light may include light from a second fluorescence emission peak emitted by excited fluorescent compounds bound to a target compound in the sample 404. In additional embodiments, the difference in wavelength between the second wavelength of light and the first wavelength of light may be greater than or about 50 nm, greater than or about 55 nm, greater than or about 60 nm, greater than or about 65 nm, greater than or about 70 nm, greater than or about 75 nm, greater than or about 80 nm, greater than or about 85 nm, greater than or about 90 nm, greater than or about 95 nm, greater than or about 100 nm, or more. In some embodiments, the second wavelength of light is less than the first wavelength of light. In additional embodiments, the second wavelength of light is greater than the first wavelength of light. In more embodiments, the second wavelength of light may be characterized as visible light having a wavelength in the range of 350 nm to 750 nm. In further embodiments, the second wavelength of light may be characterized as near-infrared light having a wavelength range of 750 nm to 2000 nm. In still more embodiments, the second wavelength of light may have a peak wavelength of emitted light that is characterized by a full-width-half-maximum (FWHM) spectral width of less than or about 100 nm, less than or about 75 nm, less than or about 50 nm, less than or about 25 nm, less than or about 20 nm, less than or about 15 nm, less than or about 10 nm, less than or about 5 nm, or less.

Methods 200, 300 may additionally include generating a sample image at operations 230, 330. In embodiments, the sample image may be generated from the light detected at the detector 408 and processed into an image at processor 412. In further embodiments, the first and second wavelengths of light collected at detector 408 are both in focus at the detector due to the adjustments made to the lens 406 and/or sample holder 402 to correct for the chromatic focal shift of the different wavelengths passing through the lens. In yet further embodiments, the image generated by processor 412 may include spatial regions that represent emissions of light of both the first and the second wavelengths. The spatial regions of both the first and the second wavelengths of light may have the same level of focus due to the correction in the chromatic focal shift performed by the methods and systems according to embodiments of the present technology.

It should be appreciated that embodiments of the present technology also include the detection and imaging of light at additional wavelengths beyond the first and second wavelengths. In embodiments, these additional wavelengths may include a third wavelength of light, a fourth wavelength of light, a fifth wavelength of light, a sixth wavelength of light, or more. In these embodiments, the operations described in methods 200, 300 may be used to measure the additional wavelengths and measure their chromatic focal shift. This information may be input to the controller in electronic communication with the piezoelectric actuator 410 to adjust a distance (d1) between the lens 406 and sample holder 402 or to adjust the lens shape so that the focal point of the additional wavelengths remain fixed on the detector 408. In further embodiments, all the wavelengths of light included in the adjustments to correct chromatic focal shifts may be incorporated into an image generated by the processor 412. The spatial regions of all the wavelengths of light may have the same level of focus due to the correction in the chromatic focal shifts performed by the methods and systems according to embodiments of the present technology.

In the preceding description, for the purposes of explanation, numerous details have been set forth in order to provide an understanding of various embodiments of the present technology. It will be apparent to one skilled in the art, however, that certain embodiments may be practiced without some of these details, or with additional details. For example, other substrates that may benefit from the wetting techniques described may also be used with the present technology.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included. Where multiple values are provided in a list, any range encompassing or based on any of those values is similarly specifically disclosed.

As used herein and in the appended claims, the singular forms “a”, “an”, and “the” include plural references unless the context clearly dictates otherwise. Thus, for example, reference to “a compound” includes a plurality of such compounds, and reference to “the period of time” includes reference to one or more periods of time and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

What is claimed is:

1. A method of correcting chromatic focal shift comprising:
measuring a chromatic focal shift in focal points of a lens between first and second wavelengths of light passing through the lens;
detecting the first wavelength of light from a sample spaced at a first distance between the sample and the lens that corresponds to a first focal point for the first wavelength of light;
adjusting the sample and the lens to a second distance with a piezoelectric actuator, wherein the second distance is determined using the measurement of the chromatic focal shift between the first and second wavelengths of light passing through the lens; and
detecting the second wavelength of light from the sample spaced at the second distance between the sample and the lens, wherein the second distance corresponds to a second focal point for the second wavelength of light.

2. The method of claim 1, wherein the first and second wavelengths of light are wavelengths of visible light or near-infrared light.

3. The method of claim 1, wherein the first wavelength and the second wavelength of light differ in wavelength by greater than or about 50 nm.

4. The method of claim 1, wherein the piezoelectric actuator moves the lens to the second distance while the sample remains stationary.

5. The method of claim 1, wherein the piezoelectric actuator moves the sample to the second distance while the lens remains stationary.

6. The method of claim 1, wherein the method further comprises adjusting a focusing power of the lens, wherein the focusing power of the lens is adjusted by adjusting a shape of the lens or a refractive index of the lens to reduce a change in a focal point of the lens due to the chromatic focal shift.

7. The method of claim 1, wherein the first and second wavelengths of light correlate with emission wavelengths of one or more fluorescent dyes present in the sample.

8. The method of claim 1, wherein the sample comprises a dyed nucleic acid polymer.

9. A method of adjusting a lens to correct chromatic focal shift comprising:
measuring a chromatic focal shift in focal points of a lens between first and second wavelengths of light passing through the lens;
detecting the first wavelength of light from a sample, wherein the lens has a first focusing power that creates a first focal point corresponding to a fixed distance between the sample and a detector for the first wavelength of light from the sample;
adjusting the lens to a second focusing power, wherein the second focusing power of the lens creates a second focal point corresponding to the fixed distance between the sample and the detector for the second wavelength of light from the sample, and wherein the second focusing power is determined using the measurement of the chromatic focal shift between the first and second wavelengths of light passing through the lens; and
detecting the second wavelength of light from the sample.

10. The method of claim 9, wherein the adjustment of the lens to the second focusing power comprises adjusting a shape of the lens with a piezoelectric actuator, and wherein the piezoelectric actuator adjusts the lens from a first shape at the first focusing power to a second shape at the second focusing power by stretching the lens to reduce a thickness in a central portion of the lens.

11. The method of claim 9, wherein the adjustment of the lens to the second focusing power comprises adjusting a refractive index of the lens by applying an electric field to the lens, wherein the electric field adjusts the lens from a first refractive index at the first focusing power to a second refractive index at the second focusing power.

12. The method of claim 9, wherein the method further comprises adjusting the sample and the lens a second distance apart that is different than the fixed distance, and detecting a third wavelength of light from the sample that is different than the first or second wavelength of light, wherein the second distance corresponds to a third focal point for the third wavelength of light.

13. The method of claim 9, wherein the first wavelength and the second wavelength of light differ in wavelength by greater than or about 50 nm.

14. The method of claim 9, wherein the sample comprises a dyed nucleic acid polymer.

15. A microscope system comprising:
a lens and a support operable to secure a sample in a position where at least a portion of light emitted by the sample is focused by the lens on a detector;
a piezoelectric actuator coupled to one or both of the lens and the support, wherein the piezoelectric actuator is operable to adjust a distance between the lens and the support; and
a controller operable to be in electronic communication with the piezoelectric actuator, wherein the controller is operable to instruct the piezoelectric actuator to adjust a distance between the lens and the support to focus different wavelengths of the light emitted by the sample on the detector.

16. The system of claim 15, wherein the system further comprises a light source operable to illuminate the sample secured to the support with a fluorescence excitation light.

17. The system of claim 15, wherein the different wavelengths of the light emitted by the sample comprise first and second wavelengths of light, and wherein the first and second wavelengths of light differ in wavelength by greater than or about 50 nm.

18. The system of claim 17, wherein the first and second wavelengths of light comprise visible light or near-infrared light.

19. The system of claim 15, wherein the lens comprises a translucent organic polymer that is operable to change shape.

20. The system of claim 15, wherein the lens comprises a liquid crystal material that is operable to change a refractive index of the lens in response to a change in an electric field applied to the lens.
